(19) United States
(12) Patent Application Publication
(10) Pub. No.: US 2009/0208620 A1
(43) Pub. Date: Aug. 20, 2009

(54) Alimentary Compositions and Methods For Metabolic Modulation

(75) Inventors: Dusan Miljkovic, San Diego, CA (US); Jovan Hranisavljevic, (US); Zbigniew Pietrzkowski, Dyer, IN (US); John Hunter, South Holland, IL (US); Jeff Van Drunen, South Holland, IL (US)

Correspondence Address: FISH & ASSOCIATES, PC;ROBERT D. FISH, 2603 Main Street, Suite 1000, Irvine, CA, 92614-6232, US

(73) Assignee: VDF FUTURECEUTICALS, INC., Momence, IL (US)

(21) Appl. No.: 12/419,553

(22) Filed: Apr. 7, 2009

Related U.S. Application Data
(62) Division of application No. 10/567,868, filed on Sep. 27, 2006, now abandoned.
(60) Provisional application No. 60/493,447, filed on Aug. 8, 2003.
(60) Provisional application No. 60/499,637, filed on Sep. 2, 2003.
(60) Provisional application No. 60/501,660, filed on Sep. 9, 2003.
(60) Provisional application No. 60/511,746, filed on Oct. 15, 2003.
(60) Provisional application No. 60/562,384, filed on Apr. 14, 2004.
(60) Provisional application No. 60/562,496, filed on Apr. 14, 2004.

(51) Int. Cl. G09F 23/00

(52) U.S. Cl. 426/383

(57) ABSTRACT

Contemplated food products include compounds with cytokinin activity to modulate glucose and/or lipid metabolism, and in especially preferred aspects contemplated food products include one or more naturally occurring cytokinins (e.g., kinetin, N2-acetylguanine, zeatin, dihydrozeatin) at a concentration effective to prevent or treat pre-diabetes, insulin resistance, type-2 diabetes, syndrome X, and/or dyslipidemia. Methods of marketing such products are also contemplated.

This application is a divisional application of our copending U.S. application with the Ser. No. 10/567,868, which was filed Sep. 27, 2006 which is a national phase of PCT application number PCT/US04/25026 filed Aug. 3, 2004 which claims the benefit of our U.S. Provisional Patent Applications with the Ser. Nos. 60/493,447, 60/499,637, 60/501,660, 60/511,746, 60/562,384, and 60/562,496, which were filed Aug. 8, 2003, Sep. 2, 2003, Sep. 9, 2003, Oct. 15, 2003, Apr. 14, 2004, and Apr. 14, 2004, respectively.

### FIELD OF THE INVENTION

The field of the invention is compositions and methods for food products and nutritional supplements, especially as they relate to those exhibiting metabolic modulation.

### BACKGROUND OF THE INVENTION

Pre-diabetes, insulin resistance, type-2 diabetes (a.k.a. non-insulin dependent diabetes, NIDDM), syndrome X, and dyslipidemia pose a substantial health threat to a significant portion of the population in the US and other industrialized nations.

For example, about 6.3% of all US citizens are diagnosed with diabetes, and another 5.2 million people are suspected to be undiagnosed (National diabetes fact sheet: General information and national estimates on diabetes in the United States, 2003. Rev ed. Atlanta, Ga.: U.S. Department of Health and Human Services, Centers for Disease Control and Prevention, 2004). Worse yet, about 40 percent of U.S. adults ages 40 to 74 currently satisfy the conditions for a positive diagnosis of pre-diabetes, which frequently progresses to type 2 diabetes within 10 years unless treated (Press release U.S. Department of Health and Human Services, Apr. 4, 2004: Revised Definition Of Pre-Diabetes).

With respect to syndrome X (defined as a constellation of metabolic abnormalities in serum or plasma insulin/glucose level ratios, lipids, uric acid levels, vascular physiology, and coagulation factor imbalances by the American Association of Clinical Endocrinologists), it is estimated that about 20% of adults in the U.S. will fall within the diagnostic criteria, with a prevalence approaching 50% in the elderly (News release: American Association for Clinical Chemistry, (2004)). Similarly, a significant fraction of the U.S. population is diagnosed with dyslipidemia. For example, approximately 29% of the U.S. population are thought to require dietary intervention for high blood cholesterol (Centers for Disease Control and Prevention in JAMA. 1993 Jun. 16; 269(23):3009-14).

Numerous efforts are presently known to prevent and treat syndrome X, pre-diabetes, insulin resistance, and/or NIDDM. While pharmacological intervention has provided at least some success in normalizing blood chemistry of patients diagnosed with one or more of the above diseases, quality of life and life expectancy often failed to improve to the same degree. Therefore, alternative approaches to prevention and/or treatment of these diseases have been developed, and typically include increased exercise, decrease of caloric intake, and increase in fiber in the diet. However, increase in exercise and decrease in caloric intake generally enjoy less popularity, and not surprisingly, a relatively large market has developed for nutritional supplements that are marketed as addressing such problems.

### Nutritional Supplements and Modified Food Products

Numerous nutritional supplements are advertised as modulating metabolism. Among other things, various chromium compounds and food products containing such compounds may be ingested to increase glucose utilization. However, at least some of these nutritional supplements exhibit significant toxicity (e.g., Cr-picolinate). In other chromium-containing supplements, the chromium has only relatively low solubility and/or bioavailability, and such supplements are therefore less, if at all, effective.

In another example, phytosterols have been demonstrated to reduce serum cholesterol, which appears as an attractive route to prevent and even treat certain forms of dyslipidemia (see e.g., Curr Opin Lipidol. 2004 February; 15(1):37-41). While phytosterols are typically well tolerated, biological effects of long-term administration are poorly understood. Moreover, most phytosterols need to be administered in relatively high quantities and over an extended period of time to be effective. Alternatively, cholesterol levels can be reduced by ingestion of barley or barley extracts. For example, certain barley extracts were reported by Miljkovic et al. in WO 2004/021980 (incorporated by reference herein) as having effect on certain diseases that are associated with AMPK dysregulation (see also WO 02/072148 and WO 01/66146 to Miljkovic et al., both of which are incorporated by reference herein). However, to achieve at least some cholesterol-reducing effect, such products need to be ingested in relatively large amounts.

In yet further examples, body fat is purportedly metabolized at an elevated rate to reduce weight using various herbal formulations or synthetic steroid-like compounds. However, the advertised effect in many cases is significantly different from the actual effect. Moreover, and especially where a person exceeds recommended dosages for a steroid-like product, serious health complications may arise. In still other examples, amino acids and/or vitamins are advertised as being effective modulate metabolism to increase muscle mass. However, such statements are typically not verified or endorsed by the FDA, and the efficacy for the advertised purpose is questionable for all or almost all of these supplements.

### Cytokinins

Cytokinins have been implicated in numerous aspects of growth and development in plants, and typical cytokinin-modulated processes include cell division, shoot initiation and growth, leaf senescence, and photomorphogenic development (see e.g., Mok, D. W. S., and M. C. Mok. 1994, Cytokinins: Chemistry, Activity and Function: CRC Press, Boca Raton, Fla.). Most naturally occurring cytokinins are adenine derivatives with distinct substitutions attached to the N⁶-position of the adenine ring. Exemplary N⁶-substituents include isoprenoid side chains, and cycloalkyl structures. For further review of structure, biological action, and other relevant properties of cytokinins, reference is made to “The Arabidopsis Book”, by Joseph Kieber on pages 1-25.

Remarkably, cytokinins were also detected in human urine (Biochem Biophys Res Commun. 2000 Dec. 9; 279(1):69-73), and numerous effects of cytokinins and cytokinin ribosides are reported in the relevant literature. For example, Wyszko et al. attribute anti-oxidant properties to cytokinins (Biochim Biophys Acta. 2003 Feb. 20; 1625(3):239-45). In other uses, kinetin was reported to exhibit anti-ageing and anti-tumorigenic effect (Biochem Biophys Res Commun. 1994 Jun. 15; 201(2):665-72). In yet another contemplated human use, zeatin was suggested as an anti-Alzheimer's drug due its inhibition of acetylcholinesterase (Mol Cells. 2002 Feb. 28; 13(1): 113-7).

The patent literature provides further uses of cytokinins and related compounds for treatment of various diseases. For example, Rattan describes in U.S. Pat. No. 5,602,139 the topical use of cytokinins to achieve healthy and youthful appearance of skin, and further teaches in U.S. Pat. No. 5,614,407 the oral use of cytokinin-containing compositions to delay morphological changes associated with ageing. Izuka describes in U.S. Pat. No. 4,629,627 use of a basidiomycetes polysaccharide extract in combination with cytokinins for treatment of viral hepatitis. Oral administration of cytokinins was reported to treat inflammation and associated discomfort as described in U.S. Pat. No. 5,151,425 to LeaLand. In still further reported uses, cytokinins were employed to treat skin hyperproliferative diseases as described in U.S. Pat. Nos. 5,021,422 and 5,164,394 to Bolund et al., while Malik reports in WO 03/094907 the topical use of cytokinins in the treatment of skin wounds, wherein cytokinins are described as increasing proliferation of fibroblasts.

In yet further known uses, cytokinins were described as therapeutic agents having anticancer, mitotic, immunosuppressive, and anti-senescent effect in human, animals, and plants as published in WO 01/49688 and WO 03/040144. Contemplated treatments for auto-immune diseases included psoriasis, multiple sclerosis, type 1 diabetes, and graft-versus-host disease.

### Cytokinin Glycosides

Cytokinin glycosides (typically N6-substituted adenosines) have also found use in various applications. For example, various N6-aralkyl substituted adenosines were found to have positive effect on the blood circulation of the coronary artery vasculature as described in U.S. Pat. Nos. 3,506,643 and 3,502,649 to Thiel et al. Furthermore, Storck et al. reported certain N6-substituted adenosines as having anti-lipolytic and anti-hyperlipidemic effect as described in U.S. Pat. No. 3,851,056. Similarly, Kampe et al. described in U.S. Pat. No. 3,509,129 selected N6-aralkyl substituted adenosines as coronary dilating agents. Antiviral and anti-prion use of selected cytokinin ribosides was reported in U.S. Pat. No. 5,681,831 to Pendergast. In still other uses, cytokinin glycosides were demonstrated to have therapeutic use to treat gastroesophageal reflux, delayed gastric emptying, or irritable bowel syndrome as described in U.S. Pat. No. 5,055,569 to Becker et al., and Jacobson et al. described in U.S. Pat. No. 5,688,774 various cytokinin glycosides as A3 adenosine receptor agonists.

Further heterocyclic compounds (e.g., substituted benzimidazoles, multi-substituted purines, etc.) were reported as having anti-viral, and antineoplastic effect, or as having anti-apoptotic effect. Exemplary compounds and uses are described in U.S. Pat. No. 6,482,843 to Quada Jr., US2003/0069259 to Borcherding et al. and U.S. Pat. No. 6,413,974 to Dumont et al.

Thus, while numerous compositions and methods for metabolic control are known in the art, all or almost all of them, suffer from one or more disadvantages. Similarly, numerous uses for cytokinins are known in the art. However, none of the known methods teaches or suggests use of cytokinins for specific metabolic modulation, and particularly modulation of glucose and/or lipid metabolism. Therefore, there is still a need for improved alimentary compositions, and especially for alimentary compositions that effect modulation of glucose and/or lipid metabolism.

### SUMMARY OF THE INVENTION

The present invention is directed to various alimentary compositions and methods of metabolic modulation, and particularly to those in which a cytokinin is included to achieve a desirable metabolic effect. Especially preferred metabolic effects include modulation of lipid and/or glucose metabolism, while especially preferred cytokinins include naturally occurring cytokinins and cytokinin glycosides.

In one aspect of the inventive subject matter, a food product for human consumption is fortified with an isolated cytokinin, and the food product further includes an information that associates its cytokinin content with modulation of glucose metabolism and/or lipid metabolism.

In another aspect of the inventive subject matter, a food product is fortified with a cytokinin-containing composition, wherein the cytokinin-containing composition is present in the fortified product in an amount sufficient to achieve a predetermined quantity of a cytokinin in the fortified product, and wherein the food product further includes information that associates cytokinin content with modulation of glucose metabolism and/or lipid metabolism.

In a further aspect of the inventive subject matter, a food product is associated with a first information that the product includes a cytokinin, and with a second information that the cytokinin modulates glucose metabolism and/or lipid metabolism.

In yet another aspect of the inventive subject matter, a food product has a cytokinin content of at least 0.5 mg per serving size, wherein the food product is not a dietary supplement. Alternatively, the food product is a dietary supplement with a cytokinin content of at least 0.5 mg per serving size and further includes an information that associates cytokinin content with modulation of at least one of glucose metabolism and lipid metabolism.

Consequently, a method of marketing a food product may include a step of increasing a cytokinin content of the product, and a further step of advertising the increased cytokinin content. Therefore, a method of marketing a food product for human consumption will also include a step of providing information on a cytokinin content of the product.

Alternatively, or additionally, contemplated methods of marketing a cytokinin comprises a step of providing information that the cytokinin modulates at least one of glucose metabolism and lipid metabolism when administered to a mammal.

In still further contemplated aspects of the inventive subject matter, a method of marketing a cytokinin-containing product will comprise a step of determining a cytokinin content of the product. In another step, information is provided that the cytokinin-containing product modulates at least one of glucose metabolism and lipid metabolism when administered to a mammal.

Various objects, features, aspects and advantages of the present invention will become more apparent from the following detailed description of preferred embodiments of the invention.

### DETAILED DESCRIPTION

The inventors have unexpectedly discovered that numerous cytokinins and cytokinin glycosides have various desirable biological properties in mammals that heretofore have not been recognized.

More specifically, and in one aspect of the inventive subject matter, contemplated compositions and methods have been proven effective to treat at least one of pre-diabetes, insulin resistance, type-2 diabetes, syndrome X, and dyslipidemia in human. While not limiting to the inventive subject matter, the inventors contemplate that such effects may be due to activation of GLUT4, AMPK, and/or Akt, and reduction in activity of ACC and/or HMGCoA reductase. Among other observations, the inventors noted that the above molecular effects are also reflected in the increased uptake of glucose in myocytes and adipocytes, and a decrease in hepatic gluconeogenesis.

### DEFINITION OF TERMS

The term “food product” as used herein refers to any composition of matter in solid, liquid, or other form that provides one or more nutrients (e.g., protein, carbohydrate, lipid, mineral, vitamin, etc.), fiber, and/or water in an orally administered form to an individual. Preferred food products include those that include, or are prepared from plant material (e.g., grains, fruit, vegetable, berries, etc.), animal material (e.g., beef, pork, lamb, poultry, fish, crustacean, milk, etc.), wherein such materials may be raw or at least partially processed.

Particularly preferred food products are prepared for human consumption, wherein the term “for human consumption” as used herein expressly excludes animal feed. Viewed from another perspective, and with specific reference to at least partially processed food products, only food products intended for human use fall within the scope of the definition provided above.

As also used herein, the term “fortified” refers to an addition and/or a man-made increase. Thus, a food product that is fortified with a cytokinin refers to a food product to which a cytokinin is added (e.g., admixed, coated, etc.), or which is modified to produce a higher concentration of the cytokinin as compared to the unmodified food product (e.g., via recombinant DNA, or inclusion of symbiotic or parasitic organism).

The term “cytokinin” as used herein refers to a variety of compounds with biological activity, and especially cytokinin activity. Particularly contemplated cytokinins include those having a purine scaffold, and even more preferably those having an N6-substituted adenine scaffold. However, it should be recognized that the term cytokinin also includes various compounds with a scaffold other than a purine scaffold (e.g., pyrimidine scaffold), and further specifically contemplated cytokinins are addressed below. Metformin is expressly excluded from the definition of “cytokinin” or compound with “cytokinin activity” herein. Among various other biological activities, cytokinins may be described as compounds having modulatory effect on plant cell growth and differentiation. However, and in the context of the present inventive subject matter, it should be recognized that cytokinins also have biological activity in mammalian systems, and especially human. Remarkably, cytokinins were shown to have substantial effect on glucose import and utilization in various tissues, as well as marked effect in modulation of kinase activities, and lipid profiles in vivo.

The term “cytokinin glycoside” as used herein refers to either a naturally occurring cytokinin or a synthetic cytokinin, wherein the naturally occurring cytokinin or synthetic cytokinin is covalently coupled to a carbohydrate group (or carbohydrate analog). Typically, such covalent coupling will be a glycosidic bond, and most typically with a ribose. However, other carbohydrate groups are also contemplated. For example, alternative carbohydrate groups include arabinose, erythrose, carbohydrate oligomers and polymers, and especially glucans. Further suitable carbohydrate analogs include carbocyclic compounds, non-cyclic carbohydrates, and heterocyclic compounds. Thus, the covalent bond may also be a non-glycosidic bond, and may even include a spacer having one to several carbon/non-carbon atoms that connect the cytokinin with the carbohydrate group (or carbohydrate analog). With respect to the biological effects of cytokinin glycosides, it should be noted that in some cases a biological effect is reduced or even abolished, while in other cases the biological effect is changed and/or maintained.

Unless expressly stated to the contrary, the terms “cytokinin” and cytokinin glycoside” also refer to mixtures of chemically distinct cytokinins and cytokinin glycosides, respectively. It should further be recognized that all isomeric forms of contemplated cytokinins (and mixtures thereof) are contemplated and considered suitable for use herein. Exemplary isomeric forms include stereoisomers, enantiomers, tautomers, optical isomers, etc.). Still further, there are numerous chemical modifications that can be made to convert a cytokinin to a modified cytokinin (which may or may not abolish the desired effect), and exemplary modifications include esterification, amidation, oligomerization, and other covalent additions, all of which are contemplated herein. Similarly, it should be recognized that where it is a metabolite of the cytokinin that exhibits the desired activity (or where the cytokinin is the metabolite), such metabolites are also contemplated.

As further used herein, the term “isolated cytokinin” refers to a cytokinin having a purity of at least 70%, wherein such cytokinin may be isolated from a natural source or isolated/obtained from a synthetic procedure. As still further used herein, the term “naturally occurring cytokinin” refers to a cytokinin isolated from a plant, algae, or microorganism. In contrast, the term “synthetic cytokinin” as used herein refers to a cytokinin that is isolated and/or obtained from a synthetic procedure, wherein the structure of the synthetic cytokinin may be identical with the structure of the naturally occurring cytokinin.

The term “cytokinin activity” as used herein refers to an activity that is characterized as a positive test result in at least one of the following test protocols:

(1) Soy bean callus culture: A positive test result is obtained when a test compound leads to an increase of at least 10% (and more typically at least 20%) in dry weight of the callus or at least 30% (and more typically at least 45%) in fresh weight of the callus as compared to a control without cytokinin in the callus growth medium. A general procedure is provided in U.S. Pat. No. 4,995,903 (Example 3).

(2) Cucumber cotyledon test: A positive test result is obtained when a test compound has an ED₅₀ of less than 200. The test procedure is a modification of the protocol described in Plant Physiology (1982), 69: 695 et seq., and general procedure for the cucumber cotyledon test is provided in U.S. Pat. No. 4,995,903 (Example 2).

(3) Tobacco callus test: A positive test result is obtained when a test compound leads to an increase of at least 10% (and more typically at least 20%) in fresh weight of the callus as compared to a control. A general procedure is provided in Journal of Biological Chemistry (1975), 250(18): 7343-7351.

(4) Cytokinin response regulator test: A positive test is obtained when a test compounds increases at least four of six type-A response regulators in an amount of at least 10% in a test system as described by Asakura et al. in Plant Mol Biol. 2003 May; 52(2):331-341, which is incorporated by reference herein.

(5) Alternatively, it is also contemplated that cytokinin activity may be identified by virtue of activation of AMPK, and a quantitative assay is described in Biochem. Biophys. Res. Commun. (1994), 200(3):1551-6 by Sullivan et al. (Characterization of 5′-AMP-activated protein kinase in human liver using specific peptide substrates and the effects of 5′-AMP analogues on enzyme activity). A positive test result is obtained when a test compound increases phosphorylation of a substrate at least 5% over control.

Cytokinin activity of a compound may also be identified by its ability to increase yeast fermentation in an assay as previously described. Typically, cytokinin activity is monitored by quantification of brewers' yeast fermentation rate under anaerobic conditions using a modified Warburg method (Mirsky, N. et al., J. Inorg. Biochem. 13(1):11-21 (1980), which is incorporated by reference herein):

Two grams of wet brewers yeast cells (about 20% dry weight) are suspended in fermentation medium (25 ml of 60 mM phosphate buffer, pH 5.7 and 10 ml of 5% (w/v) glucose solution), and aliquots of a cytokinin or cytokinin-containing composition are added to the fermentation medium for testing. Incubations are carried out in 50 ml fermentation flasks at 25° C. for 60 minutes. The fermentation rates are determined from the volume of CO₂ generated.

For further guidance, the following papers describe detection and/or measurement of cytokinin activity, all of which are incorporated by reference herein. Skoog et al. (1967) Phytochem. 6:1169-1192; Morris (1986) Ann. Rev. Plant Physiol. 37:509-538; Horgan (1984) in Advanced Plant Physiol. pp. 53-75; and Letham and Palni (1983) in Ann. Rev. Plant Physiol 34: 163-197.

As still further used herein, the term “prefabricated meal” refers to a combination of typically at least partially processed food products that are packaged in one unit. Prefabricated meals typically include at least two items selected from the group consisting of meat (e.g., chicken nuggets, meat balls, steak, fish, etc.), vegetables (potatoes, beans, carrots, etc.), gravy or sauce, rice (e.g., white or brown), milk or milk product, and pasta. As also used herein, the term “nutritional supplement” refers to a composition that includes as predominant component (other than carrier or otherwise inactive ingredient) one or more of a vitamin, a mineral, a metal, a sugar, an herbal extract, a cytokinin or cytokinin glycoside, and one or more compounds alleged to have a beneficial use to a person ingesting same. For example, contemplated compounds with alleged beneficial use include those supposed to stimulate muscle growth, reduce body fat, and/or serum lipids (e.g., cholesterol, triglycerides, etc.), improve glucose utilization, or improve sleep, mental clarity, and/or mood.

The term “serving size” refers to the FDA definition of a serving size. The serving size typically appears on food labels and is based on FDA-established lists of “Reference Amounts Customarily Consumed Per Eating Occasion”, which in most cases reflect the food quantities set forth in 21 CFR 101.12. Similarly, the term “recommended daily dose” refers to the amount of recommended servings (e.g., tablets, capsules, teaspoons, grams, etc.) of a nutritional supplement, wherein the recommended daily dose is associated with the nutritional supplement (e.g., printed on the package).

As still further used herein, the term “modulate glucose metabolism” means that at least one of glucose uptake into a cell and/or tissue is increased, that AMPK is activated, that Akt is activated, and/or that hepatic gluconeogenesis is increased or decreased. Therefore, and from a systemic perspective, the term “modulation of glucose metabolism” also refers to a normalization of glucose tolerance where abnormal glucose tolerance was previously observed, to a decrease of fasting and/or postprandial serum glucose concentration. Thus, it should be appreciated that compounds that modulate glucose metabolism include those for treatment of pre-diabetes, type II diabetes, syndrome X (a.k.a. metabolic syndrome), and insulin resistance. However, it should be noted that the term “modulate glucose metabolism” expressly excludes treatment of type 1 diabetes.

Similarly, the term “modulate lipid metabolism” means that at least one of a serum triglyceride concentration, serum LDL-cholesterol, serum total cholesterol, and serum fatty acid concentration is reduced, which may be concurrent with a reduction in 3-Hydroxy-3-methyl glutaryl CoA (HMGCoA) reductase expression and/or activity, and/or reduction in acetyl CoA carboxylase (ACC) activity (which may be concurrent with an increase in beta oxidation in selected tissues). Therefore, compounds that modulate lipid metabolism include those for treatment of dyslipidemia.

The term “alkyl” as used herein refers to unsaturated hydrocarbon groups in a straight, branched, or cyclic configuration (also referred to as cycloalkyl, see below), and particularly contemplated alkyl groups include lower alkyl groups (i.e., those having six or less carbon atoms). Exemplary alkyl groups are methyl, ethyl, propyl, isopropyl, butyl, sec-butyl, tertiary butyl, pentyl, isopentyl, hexyl, isohexyl, etc. The term “alkenyl” as used herein refers to an alkyl as defined above and having at least one double bond. Thus, particularly contemplated alkenyl groups include straight, branched, or cyclic alkenyl groups having two to six carbon atoms (e.g., ethenyl, propenyl, butenyl, pentenyl, etc.). Similarly, the term “alkynyl” as used herein refers to an alkyl or alkenyl as defined above and having at least one triple bond. Especially contemplated alkynyls include straight, branched, or cyclic alkynes having two to six total carbon atoms (e.g., ethynyl, propynyl, butynyl, pentynyl, etc.).

The term “cycloalkyl” as used herein refers to a cyclic alkane (i.e., in which a chain of carbon atoms of a hydrocarbon forms a ring), preferably including three to eight carbon atoms. Thus, exemplary cycloalkanes include cyclopropyl, cyclobutyl, cyclopentyl, cyclohexyl, cycloheptyl, and cyclooctyl. It should further be appreciated that cycloalkyls may also include a double or triple bond (and may therefore also be termed cycloalkenyl or cycloalkynyl). The term “aryl” as used herein refers to an aromatic carbon atom-containing ring, which may further include one or more non-carbon atoms (then also referred to as heteroaryl). Thus, contemplated aryl groups include cycloalkenyls (e.g., phenyl, naphthyl, etc.) and pyridyl. Further contemplated aryl groups may be fused (i.e., covalently bound) to another aryl group, and are thus termed “fused aryl”.

As also used herein, the terms “heterocycle”, “cycloheteroalkyl”, and “heterocyclic base” are used interchangeably herein and refer to any compound in which a plurality of atoms form a ring via a plurality of covalent bonds, wherein the ring includes at least one atom other than a carbon atom. Particularly contemplated heterocyclic bases include 5- and 6-membered rings with nitrogen, sulfur, or oxygen as the non-carbon atom (e.g., imidazole, pyrrole, triazole, dihydropyrimidine, indole, pyridine, thiazole, tetrazole etc.). Further contemplated heterocycles may be fused (i.e., covalently bound) to another ring or heterocycle, and are thus termed “fused heterocycle” or “fused heterocyclic base” as used herein.

The term “alkoxy” as used herein refers to straight or branched chain alkoxides, wherein the hydrocarbon portion may have any number of carbon atoms (and may further include a double or triple bond). For example, suitable alkoxy groups include methoxy, ethoxy, isopropoxy, etc. Similarly, the term “alkylthio” refers to straight or branched chain alkylsulfides, wherein the hydrocarbon portion may have any number of carbon atoms (and may further include a double or triple bond). For example, contemplated alkylthio groups include methylthio (MeS—), ethylthio, isopropylthio, etc. Likewise, the term “alkylamino” refers to straight or branched alkylamines, wherein the hydrocarbon portion may have any number of carbon atoms (and may further include a double or triple bond). Furthermore, the N-hydrogen of the alkylamino group may be substituted with another alkyl group. Therefore, exemplary alkylamino groups include methylamino, dimethylamino, ethylamino, diethylamino, isopropylamino, t-butylamino, etc.

The term “halogen” as used herein refers to fluorine, chlorine, bromine, and iodine.

It should also be recognized that all, or almost all of the above-defined groups may be substituted with one or more substituents, which may in turn be substituted as well. For example, where a hydrogen atom in an alkyl is substituted with an amino group, one or both hydrogen atoms in the amino group may be substituted with another group (e.g., alkyl or alkenyl).

The term “substituted” as used herein refers to a replacement of an atom or one functional group (e.g., H, NH₂, or OH) with another atom or functional group, and particularly contemplated functional groups include nucleophilic groups (e.g., —NH₂, —OH, —SH, —NC, etc.), electrophilic groups (e.g., C(O)OR, C(X)OH, etc.), polar groups (e.g., —OH), non-polar groups (e.g., aryl, alkyl, alkenyl, alkynyl, etc.), ionic groups (e.g., —NH₃⁺), and halogens (e.g., —F, —Cl). Further contemplated functional groups include NHCOR, NHCONH₂, NHCSNH₂, OCH₂COOH, OCH₂CONH₂, OCH₂CONHR, OC(Me)₂COOH, OC(Me)₂CONH₂, NHCH₂COOH, NHCH₂CONH₂, NHSO₂R, NHSO₂CF₃, OCH₂-heterocycles, PO₃H, SO₃H, (CH₂)₁₋₃COOH, CH═CHCOOH, O(CH₂)₁₋₄COOH, NHCOCH₂CH(OH)COOH, CH(COOH)₂, CH(PO₃H)₂, OCH₂CH₂CH₂COOH, NHCHO, with R being an optionally substituted alkyl, halogen, or H. Moreover, the term “substituted” also includes multiple degrees of substitution, and where multiple substituents are disclosed or claimed, the substituted compound can be independently substituted by one or more of the disclosed or claimed substituent moieties.

Thus, the term “functional group” and “substituent” are used interchangeably herein and refer to groups including nucleophilic groups (e.g., —NH₂, —OH, —SH, —NC, —CN etc.), electrophilic groups (e.g., C(O)OR, C(X)OH, C(Halogen)OR, etc.), polar groups (e.g., —OH), non-polar groups (e.g., aryl, alkyl, alkenyl, alkynyl, etc.), ionic groups (e.g., —NH₃⁺), and halogens, as well as NHCOR, NHCONH₂, NHCSNH₂, OCH₂COOH, OCH₂CONH₂, OCH₂CONHR, OC(Me)₂COOH, OC(Me)₂CONH₂, NHCH₂COOH, NHCH₂CONH₂, NHSO₂R, NHSO₂CF₃, OCH₂-heterocycles, PO₃H, SO₃H, (CH₂)₁₋₃COOH, CH═CHCOOH, O(CH₂)₁₋₄COOH, NHCOCH₂CH(OH)COOH, CH(COOH)₂, CH(PO₃H)₂, NHCHO, OCH₂CH₂CH₂COOH, etc., with R being an alkyl, halogen, or H.

As used herein, the term “AMPK” refers to adenosine 5′-monophosphate-activated protein kinase, which is described, for example by Fryer et al, in Biochem J. 2002 Apr. 1; 363 (Pt 1): 167-74. The term “Akt” as used herein refers to a serine/threonine kinase that is also known as protein kinase B (PKB) or RAC-PK (See, for example, Brazil and Hemmings, Trends Biochem Sci 2001 November; 26(11):657-64).

The term “syndrome X” as used herein refers to a condition characterized by positive diagnosis of at least two of the following: Non-insulin-dependent diabetes, blood pressure above a level considered normal, insulin level above a level considered normal, dyslipidemia, and obesity. The term “pre-diabetes” as used herein refers to a condition characterized by a fasting blood sugar of higher than 100 mg/dL, but below 140 mg/dL. The term “insulin resistance” as used herein refers to a condition characterized by a reduced sensitivity to insulin in the whole body or individual tissues, including skeletal muscle, myocardium, adipose tissue, and liver. The term “type 2 diabetes” as used herein refers to a metabolic disorder resulting from the body's inability to make enough, or properly use, insulin, which is often manifested by a fasting blood sugar of higher than 140 mg/dL. The term “dyslipidemia” as used herein refers to a condition in which at least one of triglycerides, free fatty acids, total cholesterol, and LDL-cholesterol is at a level considered above normal.

Contemplated Compounds

It is generally contemplated that all compounds having cytokinin activity are suitable for use in conjunction with the teachings presented herein. Therefore, generally contemplated compounds will include naturally occurring and synthetic cytokinins, cytokinin analogs, and their respective glycosides. Exemplary synthetic and natural cytokinins, analogs, and their glycosides are described in more detail below.

In one group of contemplated compounds, suitable cytokinins, cytokinin glycosides, and cytokinin analogs will have a structure as disclosed in our co-pending provisional patent application with the Ser. No. 60/493,447, filed Aug. 8, 2003, which is incorporated by reference herein. Alternatively, or additionally, suitable further contemplated cytokinins, cytokinin glycosides, and cytokinin analogs will have a structure according to Formula (I), Formula (II), or Formula (III) below:

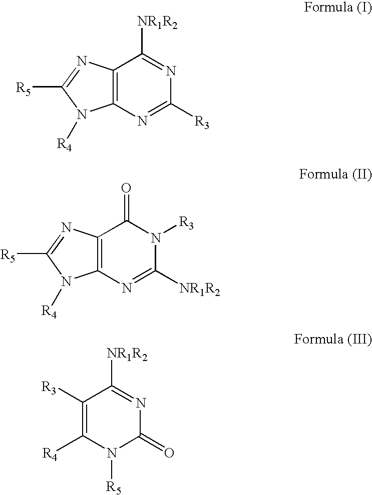

wherein R₁ and R₂ are independently H, optionally substituted alkyl, optionally substituted alkenyl, optionally substituted alkynyl, optionally substituted aryl, optionally substituted alkaryl, optionally substituted heteroaryl, optionally substituted heterocycle, OH, NOH, CN, NR₃R₄, NHCOR, NHCONH₂, NHCSNH₂, OCH₂COOH, OCH₂CONH₂, OCH₂CONHR, OC(Me)₂COOH, OC(Me)₂CONH₂, NHCH₂COOH, NHCH₂CONH₂, NHSO₂R, NHSO₂CF₃, OCH₂-heterocycles, PO₃H, SO₃H, (CH₂)₁₋₃COOH, CH═CHCOOH, O(CH₂)₁₋₄COOH, NHCOCH₂CH(OH)COOH, CH(COOH)₂, CH(PO₃H)₂, NHCHO, OCH₂CH₂CH₂COOH, in which R is R₃, and

wherein R₃, R₄, and R₅ are independently H, halogen, optionally substituted alkyl, optionally substituted alkenyl, optionally substituted alkynyl, optionally substituted aryl, optionally substituted alkaryl, optionally substituted heteroaryl, optionally substituted heterocycle, NH₂, OH, NOH, CN, CF₃, O-alkyl, S-alkyl, NH-alkyl, carbohydrate radical (more preferably monosaccharide radical, and most preferably furanosyl), carbocyclic radical, or carbohydrate analog radical. Alternatively, or additionally numerous suitable substituted purines are described in Phytochemistry 10(1), 23-8, 1971; and ibid, 7(11), 1989-94, 1968, incorporated by reference herein.

Still further especially contemplated purine-type cytokinin analogs include N⁶-alkoximinoalkyl substituted purine compounds, and exemplary compounds having cytokinin activity and their synthesis are described in U.S. Pat. No. 5,211,738 to Sasaki et al, which is incorporated by reference herein. Alternatively, the N⁶-substituent may also include a N-mono- or N-disubstituted group, and exemplary compounds with cytokinin activity and their synthesis are described in U.S. Pat. No. 5,244,487 to Oritani et al., which is also incorporated by reference herein.

Where it is desired that the purine substituent in the 6-position should be relatively large (and optionally distal to the heterocyclic base via a linker), adamantyl or diamantyl-6-substituted purines may be employed. Various such compounds with cytokinin activity and their synthesis are described in U.S. Pat. No. 4,751,292 to Fox, which is incorporated by reference herein. Of course it should be recognized that the purine scaffold of such alternative compounds listed above may further be substituted as depicted in Formula (I) above. Further contemplated purine-type compounds with cytokinin activity include those described in U.S. Pat. No. 2,903,455, which is incorporated by reference herein.

In still further preferred aspects of the inventive subject matter, the inventors generally contemplate that one or more of the heteroatoms in the purine scaffold may be replaced by another heteroatom (most typically S, Se, or O), or a substituted carbon atom, wherein the substituent is defined as R₃ in Formula (I) above. Furthermore, the purine scaffold may also be modified such that the five-membered ring is replaced a six-membered ring (preferably with a double bond, and most preferably with at least two conjugated double bonds). Suitable six-membered rings may include one or more heteroatoms (e.g., N, S, and/or O), and additional substituents, including those listed above as R₃ in Formula (I). Thus, exemplary suitable compounds with cytokinin activity will include, for example, various pyrido[3,4-d]pyrimidine derivatives, and exemplary compounds with cytokinin activity and their synthesis are described in Agri. Biol. Chem. (1986), 50: 495-97, which is incorporated by reference herein. Further contemplated heterocyclic non-purine compounds with cytokinin activity are described in U.S. Pat. No. 5,350,749 to Hackler et al., and Nishikawa, S. et al., Preparation and Structure-Activity Relationships of 4-Substituted Amino-2-methylpyrido[3,4-d]pyrimidines as Cytokinin Analogs, J. Agric. Food Chem. vol. 43, pp. 1034-1038 (1995), both of which are incorporated by reference herein.

Therefore, in another particularly preferred aspect of the inventive subject matter, suitable compounds include N6-benzyladenine, N6-benzyladenine hydrochloride, N6-benzyladenosine, N6-benzyladenine-3-glucoside, N6-benzyladenine-7-glucoside, N6-benzyladenine-9-glucoside, N6-benzyl-9-(2-tetrahydropyranyl)adenine, N6-benzyladenosine-5′-monophosphate, dihydrozeatin, dihydrozeatin riboside, dihydrozeatin-7-β-D-glucoside, dihydrozeatin-9-β-D-glucoside, dihydrozeatin-O-glucoside, dihydrozeatin-O-glucoside riboside, dihydrozeatin riboside-5′-monophosphate, dihydrozeatin-O-acetyl, N6-isopentenyladenine, N6-isopentenyladenosine, N6-isopentenyladenosine-5′-monophosphate, N6-isopentenyladenine-7-glucoside, N6-isopentenyladenine-9-glucoside, 2-methylthio-N6-isopentenyladenosine, 2-methylthio-N6-isopentenyladenine, 2-thio-N6-isopentenyladenine, 2-benzylthio-N6-isopentenyladenine, kinetin, kinetin riboside, kinetin-9-glucoside, kinetin riboside-5′-monophosphate, meta-topolin, meta-topolin riboside, meta-topolin-9-glucoside, ortho-topolin, ortho-topolin riboside, ortho-topolin-9-glucoside, trans-zeatin, trans-zeatin riboside, cis-zeatin, cis-zeatin riboside, trans-zeatin-7-glucoside, trans-zeatin-9-glucoside, trans-zeatin-O-glucoside, trans-zeatin-O-glucoside riboside, trans-zeatin riboside-5′-monophosphate, trans-zeatin-O-acetyl, 2-chloro-trans-zeatin, N2-acyl-guanine, N2-acyl-guanosine, 2-methylthio-trans-zeatin, and 2-methylthio-trans-zeatin riboside, each of which may further be substituted (e.g., acylated, acetylated, or heteroacylated), and/or be present in form of a pharmaceutically acceptable salt.

In another group of contemplated compounds, it should be appreciated that suitable cytokinins and cytokinin analogs need not be limited to compounds having a purine scaffold or a purine analogous scaffold as exemplarily described above. Numerous compounds with cytokinin activity are known in the art that include a substituted urea or thiourea scaffold, and all of such compounds are contemplated suitable for use in conjunction with the teachings presented herein.

For example, 1-morpholino-3-phenylurea has been shown to have cytokinin activity in a cellular assay Bruce, Proc. Roy. Soc (London) Ser. B 165 (1966) 245-265. In another example, numerous substituted pyridyl(thio)ureas (e.g., N-(2-substituted-4-pyridylureas)) have been demonstrated to have cytokinin activity as described in U.S. Pat. No. 4,279,639, to Okamoto et al., which is incorporated by reference herein. Various substituted phenyl pyridinyl ureas have been described. For example, Bruce M I, Zwar J A, Proc Roy Soc (London), Sec. B. 165 (999), 1966, 245-65 disclose many N-mono- and N,N′-disubstituted ureas having cytokinin activity. N-(3,4-dichlorophenyl)-N′-3- and 4-pyridinyl ureas show such activity whereas the corresponding 2,5-dichloro compounds were inactive. In general, the authors concluded that phenyl ring substitution enhanced activity with meta substituents providing highest activity and ortho substituents lowest activity.

Similarly, various substituted pyridazine ureas and thioureas have been reported to have cytokinin activity, and exemplary compounds with such activity and their synthesis is described in U.S. Pat. No. 4,331,807, to Okamoto et al., which is incorporated by reference herein. Yet further urea-type cytokinins suitable for use in conjunction with the teachings presented herein include multi-substituted pyridinyl-phenyl ureas and thioureas (e.g., N-(2,6-disubstituted 4-pyridyl)-N′-phenylurea) as described by Isogai et al. in U.S. Pat. No. 4,308,054, which is incorporated by reference herein.

Alternatively, one or both of the (hetero)aryl and/or heterocyclic substituents of the nitrogen in the urea or thiourea may be replaced by one or more iminoamine groups to form an oligo(iminoamine) with significant cytokinin activity. Exemplary oligo(iminoamine) compounds and their cytokinin activity and synthesis are described in U.S. Pat. No. 4,571,434 to Hashizume et al, which is incorporated by reference herein. On the other hand, where it is desirable to replace the oxygen or sulfur of a urea or thiourea with a nitrogen or substituted nitrogen, substituted guanidines with cytokinin activity may be obtained. For example, particularly active guanidine compounds (e.g., alkyl, alkenyl, and/or alkynyl-substituted nitroguanidines) may be prepared as described in U.S. Pat. No. 4,995,903 to Lutz et al., which is incorporated by reference herein. See also: Rodaway, “Substituted nitroguanidines provide cytokinin activity during in vitro cultivation of plant tissues,” Plant Cell Reports, 12:273-277 (1993), which is incorporated by reference herein.

In yet another group of contemplated compounds, substituted sulfonamides (e.g., O-sulfamylalkylbenzenesulfonamides) may be employed in conjunction with the teachings presented herein, and especially preferred sulfonamide compounds include those described by Sauers in U.S. Pat. No. 4,397,679, which is incorporated by reference herein. Further contemplated compounds also include various substituted ethanolamines with cytokinin activity, and especially those that include at least one aromatic group coupled to the amino group. For example, suitable N-dialkyl-alkaryl-substituted ethanolamines are described in U.S. Pat. No. 4,929,267 to Suzuki et al., which is incorporated by reference herein.

Thus, and viewed from another perspective, suitable non-purine compounds with cytokinin activity may have a general structure according to Formula (IV)

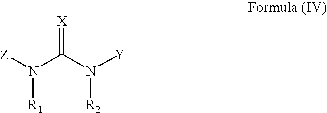

in which X is O, S, or NR₃, Y and Z are independently H, a polar group, optionally substituted alkyl, optionally substituted alkenyl, optionally substituted alkynyl, optionally substituted aryl, optionally substituted alkaryl, optionally substituted heteroaryl, optionally substituted heterocycle, R₁ and R₂ are independently H, optionally substituted alkyl, optionally substituted alkenyl, optionally substituted alkynyl, optionally substituted aryl, optionally substituted alkaryl, optionally substituted heteroaryl, optionally substituted heterocycle, OH, NOH, CN, or NR₃R₄, and wherein R₃ and R₄ are independently H, optionally substituted alkyl, optionally substituted alkenyl, optionally substituted alkynyl, optionally substituted aryl, optionally substituted alkaryl, optionally substituted heteroaryl, optionally substituted heterocycle, NH₂, OH, NOH, CN, CF₃, O-alkyl, S-alkyl, or NH-alkyl.

In a yet further contemplated group of suitable compounds, non-homogenous preparations of mycelia of and growth medium for various basidiomycetes have shown significant cytokinin activity, and exemplary preparations and activities are described in U.S. Pat. No. 4,281,021 to Iizuka et al., which is incorporated by reference herein.

It should especially be appreciated that contemplated compounds may be present in various forms, including stereoisomeric forms (e.g., diastereomers, enantiomers), tautomeric forms (e.g., keto-enol tautomers), and may exhibit optical activity (e.g., (+) or (−) rotation), or may be present as salts, hydrates, oligomers, polymers, prodrugs, or metabolites, all of which are expressly contemplated herein. Contemplated compounds may further be present as isolated compounds, as mixtures of pure compounds, and/or as mixtures of a pure compound with an isolate. Alternatively, it is also contemplated that the compounds presented herein may be prepared as an extract from a natural source (e.g., plant seed, algae, fungus, etc.) and will therefore be less pure. For example, where contemplated compounds are isolated from a natural source, purity may be 70 wt % or less. On the other hand, where contemplated compounds are synthetically prepared, purity may be equal or greater than 70 wt %.

Synthesis and/or isolation of contemplated compounds is well known in the art, and exemplary isolation protocols are provided, for example, in J. Plant Res. 2003 June; 116(3):265-9, J. Chromatogr. A. 2002 Mar. 15; 950(1-2):21-9, or Anal. Biochem. 1989 December; 183(2):312-9. In one particularly preferred aspect of the inventive subject matter, the cytokinin or related compound is prepared from a plant or fungus, and particularly preferred plants include various grains (e.g., barley, wheat, oat, etc), various algae (e.g., laminaria), various dicots (e.g., soy), and preferred fungi particularly include shiitake (edodes spec.) mushrooms. It should also be recognized that contemplated compounds may be present in a form having reduced or even no cytokinin activity. For example, the cytokinin may be covalently bound to a glycoside or polysaccharide. In such cases, it is generally preferred that the polysaccharide preparation (e.g., a beta glucan product) is enriched in the cytokinin such that the cytokinin is present in an amount of at least 0.005 wt %, more typically at least 0.05 wt %, even more typically at least at least 0.5 wt %, and most typically at least 5 wt % of the total weight of the polysaccharide.

Similarly, exemplary synthetic protocols for cytokinins are well known in the patent literature, and reference is made to the cytokinin and cytokinin glycoside related patents listed above. Moreover, synthesis of libraries of substituted heterocyclic bases applicable to synthesis of contemplated compounds is described in WO03/051896, WO03/051881, WO03/051899, and WO03/051897, all of which are incorporated by reference herein to the extent that they teach synthesis of libraries of substituted heterocyclic bases applicable to synthesis of contemplated compounds.

Contemplated Food Products

It is generally contemplated that suitable food products comprise those that include, or are prepared from, a plant material (e.g., grains, fruit, vegetable, berries, etc.), animal material (e.g., beef, pork, lamb, poultry, fish, crustacean, milk, milk product, etc.), wherein such materials may be raw or at least partially processed. In further contemplated aspects of the inventive subject matter, compounds with cytokinin activity may be added to (or enriched in) any food product in any amount, wherein suitable food products may be solid or liquid (or otherwise), and provide at least one nutrient (e.g., carbohydrate, protein, lipid, mineral, vitamin, etc.), fiber, and/or water in orally administrable form. Consequently, contemplated compounds may be added to the food product in solid or liquid form. It is generally preferred that the food product is a food product for human consumption.

For example, where the food product is in solid form, contemplated food products especially comprise ready-to-consume products, including breakfast cereals, snack bars, chewing gums, baked goods (e.g., bread, cookies, etc.), prefabricated meals, fermented milk products, dietary supplements, etc., to which contemplated compounds have been added (or which have been enriched in contemplated compounds). Similarly, where the food product is in liquid form, contemplated food products especially include coffee and/or tea, carbonated beverages, milk products, fruit beverages (e.g., native juice, juice from concentrate, or beverage comprising fruit juice), sports drinks, alcoholic beverages, water, etc.

In another example, it is contemplated that the degree of processing contemplated food may vary considerably, and all degrees of food processing are deemed suitable for use herein. For example, where a food product is unprocessed (e.g., harvested fruit or vegetable), it is contemplated that the compounds according to the inventive subject matter may be added as a coating, admixture, solution, injection, or otherwise combined with the food product. On the other hand, where the food product is processed to at least some degree (e.g., physical form altered (e.g., rolled oats), or chemical composition changed (e.g., fruit extract or combination of food products)), contemplated compounds may be added as a coating, as an admixed ingredient, or may be increased by virtue of the processing. Fully processed food products especially include baked goods, prefabricated meals, soups, and other food products that were subjected to a heating step and/or step in which one food item is combined with another food item.

Depending to the particular type of food product and/or processing, it should therefore be appreciated that contemplated compounds with cytokinin activity may be added as isolated, individual compounds, and/or as mixtures of individual compounds. Thus, such compounds may be relatively pure, or present as a fraction that is enriched in one or more of such compounds. Alternatively, or additionally, the concentration of compounds with cytokinin activity in the food products may also be increased by virtue of the processing step (e.g., process that increases concentration of contemplated compound). It should further be appreciated that admixture of contemplated compounds to food products may be performed in numerous manners, and it is contemplated that all known manners are suitable for use in conjunction with the teachings presented herein.

With respect to the amount of compounds with cytokinin activity in contemplated food products it is generally preferred that the amount of such compounds is sufficient to modulate glucose metabolism and/or lipid metabolism. For example, in some aspects of the inventive subject matter, a single serving or recommended daily dose will provide sufficient amounts to modulate glucose metabolism and/or lipid metabolism. On the other hand, and especially where the food product is consumed on a daily basis, lower quantities are also considered suitable herein. Therefore, in one aspect of the inventive subject matter, contemplated food products will include compounds with cytokinin activity in an amount of between 0.01 wt % to 0.1 wt % of the food product, more preferably 0.1 wt % to 1.0 wt % of the food product, and even more preferably 1.0 wt % to 10 wt % of the food product (and even higher, for example where the food product is a dietary supplement).

Viewed from another perspective, and depending on the particular food product, it is contemplated that the compound with cytokinin activity is present in an amount of at least 0.5 mg per serving size of the food product. Thus, suitable concentrations in at least some of the food products will be in the range of 0.5 mg -50 mg per serving size, and more typically in the range of 5 mg -500 mg per serving size. Alternatively, and especially where the compound with cytokinin activity is present in a nutritional supplement, compounds with cytokinin activity may be present in an amount of at least 0.5 mg per recommended daily dose. Consequently, suitable concentrations in at least some of the dietary supplements will be in the range of 0.5 mg -50 mg per recommended daily dose, and more typically in the range of 50 mg -500 mg per recommended daily dose. Therefore, especially contemplated food products include those with a cytokinin content of at least 0.5 mg per serving size, wherein the food product is not a dietary supplement, or dietary supplements with a cytokinin content of at least 0.5 mg per serving size, wherein the supplement further comprises information that associates cytokinin content with modulation of glucose metabolism and/or with modulation of lipid metabolism (see below).

In still further aspects of the inventive subject matter, it should be recognized that contemplated food products may include additional components with at least perceived or demonstrated nutraceutical value. For example, especially preferred additional components will include those known or alleged to improve metabolism, and especially to improve glucose utilization and/or lipid reduction. Particularly preferred additional components include chromium-containing compounds, and most preferably in a matrix, formulation, and/or complex as described in our co-pending provisional application with the Ser. No. 60/501,660, which is incorporated by reference herein. Alternatively, numerous other nutritional supplements may be combined with the compounds contemplated herein, and exemplary supplements include vitamins, minerals (e.g., boron-complexes, and particularly those described in U.S. Pat. No. 6,696,419, which is incorporated by reference herein), amino acids, biotin, bioflavanoids, herbal formulations, plant extracts, etc. Further contemplated additional components (especially for lipid modulation) include phytosterols, bran, and/or coenzyme Q10. Alternatively, it should also be appreciated that contemplated compounds may be included in a pharmaceutical composition, and suitable pharmaceutical compositions are described in our concurrently filed International application with the title “Pharmaceutical Compositions And Methods For Metabolic Modulation” (docket number 100700.0043PCT), which is incorporated by reference herein.

Exemplary Indications for Use of Contemplated Food Products

It is generally contemplated that various benefits may be derived from ingestion of the food products presented herein, and especially contemplated benefits relate to prevention, amelioration, and/or treatment of diseases or conditions associated with activation of AMPK, Akt, and/or activation of an AMPK/Akt-associated pathway.

Viewed from another perspective, it is generally contemplated that the food products according to the inventive subject matter will provide benefit to a person in need of metabolic modulation, and particularly modulation of glucose and/or lipid metabolism. Among other contemplated indications, pre-diabetes, insulin resistance, type-2 diabetes, syndrome X, and dyslipidemia are especially contemplated. The following listing provides exemplary guidance on contemplated benefits.

### Hyperglycemia

It has recently been reported that therapeutic doses of metformin increase AMPK activity in vivo in subjects with type 2 diabetes (Diabetes, 51(7): 2074-81, 2002). Metformin treatment for 10 weeks significantly increased AMPK alpha 2 activity in the skeletal muscle, and this was associated with increased phosphorylation of AMPK on Thr172 and decreased acetyl-CoA carboxylase-2 activity. The increase in AMPK alpha 2 activity was likely due to a change in muscle energy status because ATP and phosphocreatine concentrations were lower after metformin treatment. Metformin-induced increases in AMPK activity were associated with higher rates of glucose disposal and muscle glycogen concentrations. These findings suggest that the metabolic effects of metformin in subjects with type 2 diabetes may be mediated by the activation of AMPK alpha 2. Given the hypoglycemic effect imparted by the activation of AMPK, ingestion of contemplated food products to increase AMPK activity may be useful to lower blood glucose concentrations by decreasing hepatic glucose production and increasing glucose disposal in skeletal muscle.

### Insufficient Glucose Uptake in Muscle Cells

It has been observed that exercise and/or electrical stimulation of various muscles increases AMPK activity, and consequently increases glucose uptake. Based on these observations, it has been hypothesized that muscle contraction plays a role in stimulating glucose uptake in muscle, where one mechanism underlying increased uptake stems from activated AMPK increasing GLUT-4 translocation from microvesicles to sarcolemmal membranes in muscle. Based on the inventors' observation that compounds with cytokinin activity increase AMPK activity, it should be recognized that contemplated food products may be beneficial in enhancing glucose uptake into muscle cells (as well as being beneficial in ameliorating disorders that are characterized by decreased glucose uptake in muscle cells, or that are exacerbated by the effects of decreased glucose uptake in muscle cells).

### Reduced Insulin Sensitivity

Conditions and disorders associated with diminished insulin sensitivity of muscle glucose transport may be treated by administration of contemplated compounds. Various scientific reports suggest that increase in insulin sensitivity of muscle glucose transport following exercise is mediated by activation of AMPK. Thus, ingestion of contemplated food products is thought to provide increased insulin sensitivity of muscle glucose transport.

### Insulin Resistance Syndrome

Insulin resistance syndrome is associated with obesity, type 2 diabetes, and muscle paralysis (see e.g., WO 01/97816 A1 and WO 01/93874 A1). Insulin resistance syndrome is also associated with several risk factors for cardiovascular disease. In view of numerous papers suggesting that activating AMPK improves glucose tolerance, improves the lipid profile, and reduces systolic blood pressure, ingestion of contemplated food products to increase AMPK activity is deemed useful to reduce metabolic disturbances and/or to lower blood pressure characteristic of insulin resistance syndrome.

### Insulin Oversecretion

It is generally accepted in the art that activated AMPK inhibits insulin secretion, and as contemplated compounds were demonstrated to activate AMPK, it should be recognized that treatment with such compounds should provide a significant reduction in insulin secretion. Consequently, conditions associated with oversecretion of insulin may benefit from ingestion of contemplated food products.

### Dyslipidemia

Hepatic acetyl-CoA carboxylase (ACC) and 3-hydroxy-3-methylglutaryl-CoA reductase (HMGR) are targets for the AMPK system, catalyzing the key regulatory steps in fatty acid and sterol synthesis, respectively (Winder et al, Am J Physiol, 2777: E1-10, 1999, the entirety of which is herein incorporated by reference.) Activation of AMPK serves to inhibit both these lipid biosynthetic pathways, as well as triglyceride synthesis. Moreover, it is contemplated that activated AMPK inhibits the L-type pyruvate kinase and fatty acid synthase gene expression.

Reduction of activity of ACC in the liver cell also leads to a decrease in the concentration of the product of ACC, i.e., malonyl-CoA, which has marked effects on fatty acid oxidation. Malonyl-CoA is a potent inhibitor of camitine palmitoyltransferase-1 (CPT-1), the “gatekeeper” for entry of fatty acids into the mitochondria. In the liver, fatty acid oxidation can be considered to be an essential component of the pathway for synthesis of ketone bodies: Increases in fatty acid oxidation lead to increased hepatic ketogenesis. It is therefore contemplated that administration of contemplated compounds at a concentration effective to activate AMPK in the liver would result in decreases in fatty acid, triglyceride, and sterol synthesis and increases in fatty acid oxidation and ketogenesis. Viewed from another perspective, contemplated food products may be useful to increase AMPK activity and thereby reduce fatty acid synthesis, sterol synthesis, triglyceride synthesis and fatty acid synthase gene expression. Of additional benefit is also the AMPK-mediated increase in activity in fatty acid oxidation and ketogenesis, where increased ketogenesis is desired.

### Obesity

Hormone-sensitive lipase (HSL) is a target for AMPK in adipose tissue. Activation of AMPK has been shown to inhibit lipogenesis by phosphorylation of ACC and also to inhibit isoprenaline-stimulated lipolysis. Thus, contemplated food products may help reduce or even abolish lipogenesis and/or increase isoprenaline-stimulated lipolysis. Thus, and given the inhibitory role for AMPK in the process of adipose differentiation, it should be recognized that contemplated food products will likely inhibit adipogenesis.

### Reduction in Platelet Aggregation

Based on previous findings that kinetin inhibits formation of free radical of activated platelets in vitro and thrombus formation in vivo (Eur. J. Pharmacol. 2003 Apr. 4; 465(3):281-7, or Platelets. 2003 May; 14(3):189-96), the inventors contemplate that at least some of the compounds presented above may also exhibit platelet aggregation in mammals.

### Improvement in Vascular and Cardiovascular Perfusion

Based on previous findings (see e.g., U.S. Pat. Nos. 3,506,643 or 3,502,649) that certain N6-aralkyladenosine derivatives improved vascular and cardiovascular perfusion (thereby increasing oxygenation of associated tissues), the inventors contemplate that at least some of the compounds presented above may also such activity.

Therefore, it should be appreciated that contemplated food products may especially beneficial to a person to (1) reduce fatty acid synthesis, sterol synthesis, triglyceride synthesis and fatty acid synthase gene expression, (2) ameliorate one or more conditions or disorders that are characterized by elevations in one or more of the pathways or mechanisms involved in fatty acid synthesis, sterol synthesis, triglyceride synthesis and fatty acid synthase gene expression, (3) increase fatty acid oxidation and ketogenesis, (4) inhibit lipogenesis and/or isoprenaline-stimulated lipolysis, (5) ameliorate one or more conditions or disorders that are characterized by elevations in one or both of lipogenesis and isoprenaline-stimulated lipolysis pathways, or that are exacerbated by the elevations in one or both of these pathways, (6) decrease insulin secretion, (7) ameliorate one or more a conditions or disorders that are characterized by elevated insulin secretion, or that are exacerbated by insulin secretion, (8) enhance glucose uptake in muscle cells, (9) ameliorate one or more conditions or disorders that are characterized by decreased glucose uptake in muscle cells, or that are exacerbated by the effects of decreased glucose uptake in muscle cells, (10) inhibit adipogenesis, (11) ameliorate one or more conditions or disorders that are characterized by increased adipogenesis, or that are exacerbated by adipogenesis, (12) increase insulin sensitivity of muscle glucose transport, (13) lower blood glucose concentrations by decreasing hepatic glucose production and/or increasing glucose disposal in skeletal muscle, and/or (14) ameliorate one or more conditions or disorders associated with insulin resistance syndrome through improving glucose tolerance, improving lipid profile or reducing systolic blood pressure.

Contemplated Uses

Based on the inventors' findings (see experiments below) and other data (not shown), it is contemplated that food products comprising compounds with cytokinin activity are used as a dietary component in the treatment of various conditions, and particularly in treatment of pre-diabetes, insulin resistance, type 2 diabetes, syndrome X, and/or dyslipidemia. It should further be appreciated that the term “treated” or “treatment” where used in conjunction with a medical condition refers to at least one of a resolution and/or improvement in clinical parameters of clinically abnormal values, and/or to an improvement in subjective feeling of a patient diagnosed with the condition.

Particularly preferred food products will therefore be associated with an information that associates cytokinin content with modulation of glucose metabolism and/or modulation of lipid metabolism. Typically, suitable information will include printed information that is located on a packaging element (e.g., container, foil wrapper, crate, display box, etc.), or directly coupled to the food product (e.g., adhesive label on food product or packaging element). It should further be recognized that the printed information may vary considerably so long as the information associates cytokinin content with modulation of glucose metabolism and/or modulation of lipid metabolism. For example, contemplated information may be in written form, pictographic form, or combination thereof.

Cytokinin content may be referred to in quantitative terms (e.g., “contains 200 mg of cytokinins”, or “has at least 50 mg cytokinins per serving”) or qualitative terms (e.g., “high in cytokinins”, “cytokinin-rich”, or “good source of cytokinins”), and may be specific to one or more particular cytokinins (e.g., “rich in acetylguanine”, “at least 10 mg kinetin per serving”, etc).

Similarly, the association of the cytokinin content with the modulation of the glucose metabolism and/or lipid metabolism may be specific, general, or directed to a desired outcome that is associated with the modulation of the glucose metabolism and/or modulation of lipid metabolism. For example, specific association may refer to increased glucose utilization, reduction in serum blood glucose and/or serum lipids, while general information may refer to improved glucose or energy utilization, improved lipid metabolism, pre-diabetes, type 2 diabetes, insulin resistance, or reduced fat storage. In still further examples, where cytokinin content is associated with a desired outcome, the outcome may be characterized as improved health condition for the heart (e.g., “heart healthy”), or weight and/or blood sugar normalization (e.g., “weight control”, “reduces sugar cravings”).

Consequently, the food product may be associated with the information in numerous manners, and contemplated types of association include various types of advertising, which may be directly coupled to the food product (e.g., at point of sale, on the food product, or packaging of the food product) in written and/or pictographic form, or indirectly via an advertisement that connects the food product with the cytokinin content (which is associated with the metabolic modulation). Typical advertisements include printed publications, radio ads, television ads, Internet ads, etc.

Preferred food products include one or more isolated cytokinins, which may be added to the product to form a fortified product. Alternatively, where food product is fortified with cytokinin-containing composition (e.g., comprising 70 wt % or less cytokinins), it is generally preferred that an effective concentration of the cytokinin is achieved (most preferably to modulate glucose and/or lipid metabolism). Therefore, suitable food products for human consumption include those that are fortified with a cytokinin-containing composition, wherein the cytokinin-containing composition is present in the fortified product in an amount sufficient to achieve a predetermined quantity of a cytokinin in the fortified product (e.g., exogenously added cytokinin to achieve cytokinin concentration of at least 50 mg per serving size), and wherein the food product further comprises an information that associates cytokinin content with modulation of glucose metabolism and optionally further with modulation of lipid metabolism.

Consequently, and viewed from another perspective, it should be appreciated that a food product will be associated with a first information that the product includes a cytokinin, and that the product will be further associated with a second information that the cytokinin modulates glucose metabolism and/or modulates lipid metabolism. Therefore, contemplated methods of marketing a food product for human consumption will include one step in which information on a cytokinin content of the product is provided. In another (optional) step, information is provided that a cytokinin modulates at least one of glucose metabolism and lipid metabolism.

Alternatively, or additionally, a method of marketing a food product may therefore include a step of increasing a cytokinin content of the product (e.g., via concentration of the cytokinin in the food product, or adding exogenous cytokinin in form of an isolated cytokinin or an extract), and a further step of advertising the increased cytokinin content (e.g., as described above). Thus, a method of marketing a cytokinin may include a step of providing information that one or more cytokinins modulate glucose metabolism and/or lipid metabolism.

Viewed from yet another perspective, a method of marketing a cytokinin-containing product will include a step of determining a cytokinin content of the product (e.g., via various preparative or analytical methods, including chromatographic methods and/or immunoassay methods). A further step in such methods will comprise a step of providing information that the cytokinin-containing product modulates at least one of glucose metabolism and lipid metabolism when administered to a mammal.

### Experiments

### Effect of Selected Compounds on Glut-4, Activated AMPK, and Activated Akt

The levels of Glut-4, activated AMPK and activated Akt were measured in mouse muscle cells C2C12 (from ATTC) and in primary culture of human skeletal muscle cells (Clonetics, Inc.) using Western immunoblotting. C2C12 cells were plated at 1.5×1-exp5 cells per mL/well (12-well plate) in standard cell culture medium (DMEM supplemented with 10% fetal bovine serum (FBS), 25 mM glucose, 20 mM Hepes, 4 mM glutamine and 2 mM sodium pyruvate. 48 hrs after the plating, medium was changed to differentiation medium (DMEM supplemented with 5 mM of glucose and 0.5% of FBS) for next 3-4 days to stimulate the formation of myotubes. Three hours before the treatment with selected agents, cells were washed with PBS and transferred to PBS supplemented with 5 mM of glucose.

Human skeletal muscle cells (HSKM) were cultured in SKBM-2 mediums provided by Clonetics. 48 hrs after cell plating, medium was changed to SKBM medium to stimulate differentiation of the cells to myotubes. When differentiated, the myotubes were transferred to PBS supplemented with 5 mM glucose for three hrs before the treatment.

Analysis of C2C12 cells for the level of activated AMPK, Akt and the level of GLUT-4 was performed in the same experimental system. The cells were treated for 30 minutes at 37° C. After the treatment, the cells were washed with ice-cold PBS and lysed with 80 μl of lysis buffer/well (M-PER buffer from Pierce supplemented with protease and phosphatase inhibitor mix (Calbiochem) for 10 minutes on ice. Next, the plates were transferred to −20° C. to improve the lysis of the cells. Next cells were sonicated for 5 minutes and lysate was transferred to Eppendorf tubes and centrifuged at 14,000 rpm for 10 minutes. Supernatants were collected in fresh Eppendorf tubes and kept on ice to measure the amount of total proteins. 3 μl of each lysate was used to measure the protein concentration using standard Bradford method (Biorad). Subsequently, 20 μg per sample of sample protein was used for Western analysis using NuPage 10% Bis/Tris gels (Invitrogen). After exposure of membranes to primary and secondary antibodies AMPK, AKT or Glut-4 was detected using ECL-Plus (Amersham) following producer's instruction. Chemilumiscent signals were detected by using ChemiDoc system from Biorad. Intensity of detected signals were analyzed and measured using Quantity One software (Biorad). Alternatively, the level of phosphorylated AMPK was detected using ECL kit from Amersham and short exposure to Kodak films.

Experimental setup: Cell Culture was followed by treatment with selected contemplated compounds, which was followed by cell lysis and western blot analysis for AMPK, Akt, GLUT4, total AMPK, and total Akt. Signals were acquired accordingly. Primary antibodies used in these studies are the following: Anti-phospho-AMPK (Thr172), mouse, rabbit IgG, from Cell Signaling, #2531; Anti-phospho-Akt (Ser473), mouse, rabbit IgG, Cell Signaling, #9271; Anti-Glut-4, mouse, rabbit IgG, Calbiochem, #400064; Anti-AMPK (total), mouse, rabbit IgG, Cell Signaling, #2532; Anti-Akt (total), mouse, rabbit IgG, Cell Signaling, #9272.

(1) Results for AMPK Activation

The effects of various compounds (some data not shown) on AMPK activity are summarized in Table 1 below. The results demonstrate that most of the tested agents significantly stimulate AMPK activity, with some resulting in over 10 fold increases in activity compared the untreated control. The more potent compounds include derivatives of adenine, cytidine and guanosine as well as kinetin and zeatin. Table 1 refers to multiple independent experiments where multiple identical concentrations for the same reagents are indicated.

TABLE 1

| | | FOLD AMPK |
|---|---|---|
| | CONCENTRATION | ACTIVATION |
| AGENT | (microM) | (OVER CONTROL) |
| Adenosine | 12.5 | 1.83 |
| | 5.0 | 1.64 |
| | 2.5 | 1.87 |
| N⁶-Acetyl-Adenosine | 12.5 | 2.18 |
| | 5.0 | 2.41 |
| | 2.5 | 1.08 |
| Benzyl-Adenine | 50.0 | 2.92 |
| | 5.0 | 2.70 |
| | 0.5 | 2.18 |
| Gamma, Gamma- | 50.0 | 2.11 |
| Dimethylally-6- | 5.0 | 2.45 |
| Aminopurine | 0.5 | 2.82 |
| Dihydro-Zeatin | 50.0 | 0.88 |
| | 5.0 | 0.59 |
| | 0.5 | 2.25 |
| Zeatin | 1.0 | 2.33 |
| | 10.0 | 2.04 |
| | 1.0 | 2.15 |
| Trans-Zeatin | 10.0 | 4.27 |
| | 1.0 | 2.33 |
| Guanosine | 5.0 | 3.70 |
| N²-Acetyl-Guanosine | 2.0 | 2.20 |
| | 0.8 | 2.20 |
| | 0.3 | 3.75 |
| | 1.5 | 4.28 |
| | 7.5 | 1.71 |
| | 37.5 | 2.28 |
| N²-Acetyl-Guanine | 0.3 | 5.42 |
| | 1.5 | 5.85 |
| | 7.5 | 6.00 |
| | 37.5 | 6.51 |
| Kinetin | 0.8 | 3.60 |
| | 0.8 | 2.40 |
| | 2.0 | 2.70 |
| | 10.0 | 12.80 |
| | 0.1 | 5.30 |
| | 0.3 | 8.12 |
| | 1.0 | 19.50 |
| | 3.0 | 14.50 |
| Kinetin Riboside | 3.0 | 12.00 |
| Metformin | 2.0 milliM | 1.42 |
| Rosiglitazone | 3.0 | 3.50 |

### (2) Results for Akt Activity

The effects of selected compounds on Akt activity are summarized in Table 2 below. Interestingly, many of the potent AMPK stimulators had only marginal effect on Akt activity. For example, zeatin is a potent stimulator of AMPK but not Akt. However, guanosine, N²-Acetyl-Guanosine and N²-Acetyl-Guanine were observed to be potent activators of AMPK as well as Akt. Table 2 refers to multiple independent experiments where multiple identical concentrations for the same reagents are indicated.

TABLE 2

| | | FOLD AKT |
|---|---|---|
| | CONCENTRATION | ACTIVATION |
| AGENT | (microM) | (OVER CONTROL) |
| Kinetin | 5.0 | 2.07 |
| | 2.0 | 3.35 |
| | 0.8 | 3.17 |
| | 8.1 | 0.24 |
| | 2.7 | 3.21 |
| | 0.9 | 3.81 |
| | 0.3 | 5.08 |
| Kinetin Riboside | 5.0 | 3.32 |
| | 2.0 | 5.14 |
| | 0.8 | 3.71 |
| Zeatin | 10.0 | 1.36 |
| | 1.0 | 0.95 |
| Trans-Zeatin | 10.0 | 0.86 |
| | 1.0 | 0.90 |
| Gamma, Gamma- | 2.0 | 1.32 |
| Dimethylally-6- | 0.8 | 1.90 |
| Aminopurine | 0.8 | 3.56 |
| N⁴-Acetyl-Cytidine | 5.0 | 1.64 |
| | 2.0 | 1.46 |
| | 0.8 | 2.45 |
| | 5.0 | 1.36 |
| | 2.0 | 1.50 |
| N²-Acetyl-Guanosine | 5.0 | 1.23 |
| | 0.8 | 1.75 |
| | 0.3 | 1.92 |
| | 0.1 | 2.57 |
| | 2.0 | 2.17 |
| | 0.8 | 2.95 |
| | 7.5 | 1.68 |
| | 1.5 | 1.55 |
| | 0.3 | 2.57 |
| N²-Acetyl-Guanine | 7.5 | 2.58 |
| | 1.5 | 3.58 |
| | 0.3 | 3.50 |
| | 7.5 | 1.95 |
| | 1.5 | 1.64 |
| | 0.3 | 2.44 |
| AICAR | 500.0 | 5.45 |
| | 50.0 | 2.20 |
| Metformin | 20.0 milliM | 2 32 |
| | 2.0 milliM | 2.70 |
| Insulin | 0.10 nanoM | 1.75 |
| | 50.0 nanoM | 3.28 |
| | 25.0 nanoM | 3.40 |
| Rosiglitazone | 27.0 | 0.71 |
| | 9.0 | 1.78 |
| | 3.0 | 2.34 |
| | 3.0 | 5.01 |
| | 1.0 | 2.83 |

### (3) Results for GLUT-4

The effects of kinetin, N²-Acetyl-Guanosine and N²-Acetyl-Guanine on GLUT-4 protein level in C2C12 cells were investigated following the same experimental design as described for AMPK and AKT. Anti-Glut-4 antibody used in this study was from Calbiochem. The results summarized in Table 3 below demonstrate that kinetin, N²-Acetyl-Guanosine and N²-Acetyl-Guanine potently increase GLUT-4 protein level in C2C12 cells at different range and in a dose-dependent manner. Table 3 refers to multiple independent experiments where multiple identical concentrations for the same reagents are indicated.

TABLE 3

| | | FOLD CHANGE |
|---|---|---|
| | | IN GLUT-4 |
| | CONCENTRATION | LEVEL (OVER |
| AGENT | (microM) | CONTROL) |
| Rosiglitazone | 3.0 | 3.82 |
| | 9.0 | 3.61 |
| | 27.0 | 3.19 |
| | 3.0 | 2.13 |
| | 3.0 | 4.37 |
| | 3.0 | 2.98 |
| Metformin | 2000 | 1.50 |
| Kinetin | 0.3 | 3.45 |
| | 0.9 | 4.00 |
| | 2.7 | 3.88 |
| | 8.1 | 1.11 |
| | 0.8 | 3.46 |
| | 0.3 | 3.95 |
| | 0.8 | 2.36 |
| | 2.0 | 1.88 |
| N²-Acetyl-Guanine | 0.3 | 3.94 |
| | 1.5 | 3.84 |
| | 7.5 | 3.24 |
| | 37.5 | 2.80 |
| N²-Acetyl-Guanosine | 0.3 | 1.21 |
| | 1.5 | 1.74 |
| | 7.5 | 3.14 |
| | 37.5 | 3.03 |

### Glucose Uptake In Vitro

Total glucose uptake was measured using fluorescent glucose analog from Molecular Probes. Briefly, muscle cells were treated with kinetin, N²-Acetyl-Guanosine and N²-Acetyl-Guanine for 30 minutes at 37 C first and subsequently, these cells were exposed to 500 μM of fluorescent glucose analog for 5 minutes at room temperature. Next, cells were washed twice with cold Krebs-Hepes buffered solution and fixed in 70% ethanol in water. Fluorescence of fluorescent glucose in the cells was measured using fluorescent plate reader at 480/530 nm (excitation/emission). The results summarized in Table 4 below demonstrate that kinetin, N²-Acetyl-Guanosine and N²-Acetyl-Guanine each potently enhance glucose uptake in muscle cells in vitro. Table 4 refers to multiple independent experiments where multiple identical concentrations for the same reagents are indicated.

TABLE 4

| | | | FOLD CHANGE IN |
|---|---|---|---|
| | | | TOTAL GLUCOSE |
| | CONCEN- | AVERAGE | UPTAKE (OVER |
| AGENT | TRATION | (N = 3) | CONTROL) |
| N²-Acetyl- | 0.0 | 20.3 +/− 0.1 | — |
| Guanosine | 0.3 | 44.1 +/− 0.7 | 2.17 |
| | 1.5 | 54.3 +/− 0.9 | 2.67 |
| | 7.5 | 61.7 +/− 1.3 | 3.03 |
| | 0.00 | 46.5 +/− 1.2 | — |
| | 0.15 | 90.5 +/− 1.7 | 1.94 |
| | 0.75 | 109.5 +/− 2.6 | 2.35 |
| | 3.75 | 148.7 +/− 8.5 | 3.18 |
| N²-Acetyl-Guanine | 0.3 | 54.5 +/− 1.7 | 2.68 |
| | 1.5 | 55.2 +/− 0.8 | 2.71 |
| | 7.5 | 59.6 +/− 0.4 | 2.93 |
| | 0.00 | 46.5 +/− 1.2 | — |
| | 0.15 | 86.4 +/− 2.3 | 1.85 |
| | 3.75 | 115.9 +/− 3.7 | 2.48 |
| Kinetin | 0.00 | 47 +/− 0.7 | — |
| | 0.15 | 88.6 +/− 0.9 | 1.88 |
| | 0.75 | 103.3 +/− 2.1 | 2.19 |
| | 3.75 | 102.6 +/− 4.7 | 2.18 |
| | 0.0 | 28.9 +/− 0.1 | — |
| | 0.3 | 86.0 +/− 0.7 | 2.97 |
| | 1.5 | 110.6 +/− 2.3 | 3.82 |
| | 7.5 | 56.6 +/− 1.4 | 1.95 |
| Rosiglitazone | 3.0 | 47.3 +/− 1.1 | 2.33 |
| | 30.0 | 56.5 +/− 1.4 | 2.78 |
| | 0.0 | 52.1 +/− 0.2 | — |
| | 3.0 | 122.4 +/− 3.7 | 2.34 |

### Glucose Uptake in Rat Epitrochlearis Muscle

Glucose uptake in rat epitrochlearis muscle was determined following a protocol substantially as described by Brozinick, J. T., and Birnbaum, M. J. (1998) J. Biol. Chem. 273(24), 14679-146822. Results are listed in Tables 5 and 6, wherein data of Table 5 were obtained for 60 minute incubations (at 37 C), 10 minute transport at (30 C) and data of Table 6 were obtained for 60 minute incubations (at 37 C), 10 minute transport at (30 C) of the compounds as indicated (K is kinetin, AG is N2-acetylguanine).

TABLE 5

| DATA | CONTROL | K | K | AG | AG |
|---|---|---|---|---|---|
| Media | Basal | 0.5 uM | 2 uM | 0.1 uM | 0.4 uM |
| Raw | 0.55 | 0.82 | 0.57 | 0.66 | 0.63 |
| Raw | 0.48 | 0.88 | 0.90 | 1.85 | 2.28 |
| Raw | 1.23 | 1.47 | 0.64 | 0.86 | 1.61 |
| Raw | 0.69 | 0.56 | 0.81 | 0.87 | 1.35 |
| Raw | 1.35 | 1.19 | 0.57 | 1.35 | 1.27 |
| Mean | 0.82 | 0.99 | 0.70 | 1.12 | 1.43 |
| StDev | 0.38 | 0.35 | 0.15 | 0.48 | 0.60 |
| Sem | 0.15 | 0.16 | 0.07 | 0.22 | 0.27 |

TABLE 6

| DATA | CONTROL | K |
|---|---|---|
| Media | Basal | 1 uM |
| Raw | 1.06 | 1.54 |
| Raw | 0.97 | 0.95 |
| Raw | 0.72 | 1.33 |
| Raw | 1.15 | 1.10 |
| Raw | 0.78 | 1.23 |
| Mean | 0.94 | 1.23 |
| Stdev | 0.18 | 0.23 |
| Sem | 0.08 | 0.10 |

### Effect of Cytokinin-Enriched Preparations on Serum Glucose and Lipids In Vitro

Two separate cytokinin-containing extracts (PE1, PE2) were prepared from sprouted barley according to a protocol similar to the protocols presented in WO2004/021980, which is incorporated by reference herein. PE1 and PE2 were confirmed by HPLC and LC/MS to include among other compounds kinetin, dihydrozeatin, and acetylguanine. Uptake of 1-deoxy-D-[3H] glucose in primary culture of rat adipocytes was measured in presence of a combination of PE1 and PE2, insulin, and a combination PE1/PE2 and insulin. Table 7 depicts the results of this experiment in which the effect is listed as % increase of control at various concentrations for PE1/PE2.

TABLE 7

| | PE1/PE2 | PE1/PE2 + INSULIN |
|---|---|---|
| 0.05 mg/ml | 100 | 225 |
| 0.1 mg/ml | 155 | 270 |
| 1.0 mg/ml | 155 | 360 |
| 1.2 mg/ml | 150 | 340 |

Similar results were obtained in L6 muscle cells (without insulin), wherein doses of 50 microgram/ml stimulated glucose uptake over 65% as compared to control.

### Effect of Cytokinin-Enriched Preparations on Serum Glucose and Lipids in Rats

The above cytokinin-enriched preparations (PE1/PE2) were further administered to streptozocin treated rats, and the results were compared with streptozocin treated rats that received metformin as control. Administration of PE1/PE2 was at 85 mg/kg, whereas metformin was administered at 500 mg/kg. Remarkably, rats treated with PE1/PE2 showed reduced blood glucose levels comparable to Metformin, while PE1/PE2 greatly improved liver enzymes over streptozocin group and equivalent to Metformin. Furthermore, PE1/PE2 prevented body weight loss more effectively than Metformin.

### Effect of Cytokinin-Enriched Preparations on Serum Glucose and Lipids in Human

The above cytokinin-enriched preparations (PE1/PE2) were also orally administered to ten patients diagnosed with type 2 diabetes over a period of ninety days. The total daily dose was 7.5 gram (3×2.5 g) per patient, and blood analyses were performed at day 0, 45 and 90 day. Most significantly, the results unequivocally revealed a 20% decrease in fasting and postprandial serum glucose, significant improvement of glucose tolerance, 14% decrease in glycosylated hemoglobin, and a 20% decrease in LDL/HDL ratio.

### Oral Availability and Serum Determination of Selected Cytokinins

C57/B1 mice were treated with 100 microgram/dose of dihydrozeatin (DHZ) for 0, 15, 30, 60 and 120 minutes following oral or i.p. administration. Serum level of DHZ in pg/ml was measured using DHZ Elisa following procedures as enclosed in a commercially available test kit (e.g., dihydrozeatin competitive ELISA test system for plant growth hormone detection, Agdia, Elkhard, Ind.). Three animals were used per experimental point and results are summarized in Table 8.

TABLE 8

| | TIME | | | | |
|---|---|---|---|---|---|
| ROUTE | 0 | 15 | 30 | 60 | 120 |
| Oral | 300 | 952 | 1024 | 961 | 853 |
| i.p. | 300 | 1154 | 991 | 746 | 471 |

As can be clearly taken from the data, DHZ is readily bioavailable from the oral route and significant serum concentrations can be maintained over at least 120 minutes. Even more remarkably, at time point 0 minutes, the inventors discovered a significant DHZ concentration in serum, which suggests that if DHZ or other cytokinins as contemplated above is implicated in metabolic modulation (of glucose and/or lipid metabolism) and present in serum, various metabolic conditions and/or diseases may be monitored by determination of DHZ or other cytokinins. Consequently, the inventors contemplate a method of performing an analytic test in a mammal (preferably human) comprising one step in which the concentration of one or more of contemplated compounds is determined in a biological fluid. In a further step of such method, the concentration is correlated with a likelihood and/or presence of a metabolic disorder (e.g., pre-diabetes, insulin resistance, type-2 diabetes, syndrome X, dyslipidemia, or any condition that is associated with dysfunction of AMPK and/or Akt). Typically, it is expected that a decrease in the concentration of the compound in the biological fluid will be associated with the likelihood and/or presence of the metabolic disorder.

Furthermore, it is contemplated that one or more of the compounds presented herein may be a factor in a mammal that is implicated in metabolic control and therefore present at a certain serum and/or cellular concentration. In such case, depletion or one or more of such factors may lead to a metabolic disturbance, which may present a disease or condition, including pre-diabetes, insulin resistance, type-2 diabetes, syndrome X, and/or dyslipidemia. Therefore, contemplated alimentary compositions may also be advertised and/or ingested to normalize and/or enhance the cellular and/or serum concentration of the compound with cytokinin activity.

### Extracts Comprising Selected Cytokinins and Cytokinin Glycosides

Dihydrozeatin and dihydrozeatin riboside content of various sources was determined using a competitive ELISA test (sensitivity: 0.2-50 pM/mL). Sample preparation was done as follows: All extracts and powders were dissolved in TBS buffer to a final concentration of 10 mg/mL. 100 microL (equivalent to 1 mg) of each extract was used for the ELISA, and the results are provided in Table 9 below. VTB is blueberry extract. All extracts commercially available from 300 West 6th Street, Momence, Ill. It should be noted that the values in the table below represent the minimum quantities as determined, and that higher cytokinin concentrations may be achieved by modification of the isolation protocol.

TABLE 9

| SAMPLE: | [PM/MG] |
|---|---|
| VTB | 920.0 |
| Shiitake Mushroom Powder | 32.0 |
| Kale Sprout Powder | 3.0 |
| Cranberry Powder | 720.0 |
| Grape Seed Extract | 560.0 |
| Tart Cherry Powder | 18.0 |
| Brewer's Yeast Extract | 920.0 |
| Mustard seed extract Powder | 33.0 |
| Soy Sprout Powder | 4.0 |
| Broccoli Powder | 2.0 |
| VTB Powder B | >1000.0 |
| BLB Extract D | 820.0 |
| Cranberry | >1000.0 |
| Whole Coffee Berry | 780.0 |
| Aronia | >1000.0 |
| Whole Coffee Berry Extract | >1000.0 |

Thus, specific embodiments and applications of alimentary compositions and methods for metabolic modulation have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Furthermore, where a definition or use of a term in a reference, which is incorporated by reference herein is inconsistent or contrary to the definition of that term provided herein, the definition of that term provided herein applies and the definition of that term in the reference does not apply.

What is claimed is:

1. A method of marketing a food product or nutritional supplement for human consumption, the method comprising the steps of:
providing a fortified food product or nutritional supplement, wherein the fortified food product or nutritional supplement is fortified with a naturally occurring cytokinin or a composition comprising the naturally occurring cytokinin;
wherein the naturally occurring cytokinin is selected from the group consisting of a kinetin, a N2-acetylguanine, a zeatin, a dihydrozeatin, a topolin, and a benzylaminopurine; and
providing an information that associates cytokinin content of the fortified food product with modulation of glucose metabolism and optionally further with modulation of lipid metabolism.

2. The method of claim 1 wherein the naturally occurring cytokinin is selected from the group consisting of a kinetin, a zeatin, and a dihydrozeatin.

3. The method of claim 1 wherein the fortified food product is selected from the group consisting of a cereal product, a snack bar, a prefabricated meal, and a beverage.

4. The method of claim 1 wherein the cytokinin is present in an amount of at least 0.5 mg per serving size or of at least 0.5 mg per recommended daily dose.

5. The method of claim 1 wherein at least a portion of the composition comprising the naturally occurring cytokinin is prepared from at least one of a plant seed, a plant sprout, and an algae.

6. The method of claim 1 wherein the naturally occurring cytokinin is synthetic.

7. The method of claim 1 wherein the modulation of glucose metabolism is selected from the group consisting of a reduction of hyperglycemia, an increase in glucose uptake into muscle cells, and an increase in insulin sensitivity.

8. The method of claim 1 wherein the modulation of lipid metabolism is reduction of at least one of a cholesterol level and a triglyceride level.

9. The method of claim 1 wherein the step of providing information comprises providing printed information located on a packaging element of the fortified food product or nutritional supplement.
